(19) United States
(12) Patent Application Publication
(10) Pub. No.: US 2021/0035071 A1
(43) Pub. Date: Feb. 4, 2021

(54) SYSTEM FOR USE IN ASSET ANALYSIS

(71) Applicant: Modla Pty Ltd, Stafford Heights (AU)

(72) Inventor: Dane Boers, Stafford Heights (AU)

(21) Appl. No.: 16/943,062

(22) Filed: Jul. 30, 2020

(30) Foreign Application Priority Data
Aug. 1, 2019 (AU) 2019902746

(51) Int. Cl. G06Q 10/00

(52) U.S. Cl. CPC G06Q 10/20

(57) ABSTRACT

A system for use in asset analysis includes: one or more asset type models, each relating to multiple individual assets having common characteristics; and a governance framework for each asset type model, the governance framework being operable to convert the asset type model into a specific asset model corresponding to a specific asset. An asset type model is converted into a specific asset model based on a plurality of decisions defined by the governance framework. The decisions defined by the governance framework are made according to input and/or known data or information relating to, and any specific asset model created using that asset type model therefore contains information about, one or more of the following: the specific asset itself, the condition of the specific asset, the operational context in which the specific asset operates; and the environment in which the specific asset operates.

### CROSS-REFERENCE TO RELATED APPLICATIONS

This application claims priority to Australian Patent Application No. 2019902746, filed on Aug. 1, 2019, entitled A SYSTEM FOR USE IN ASSET ANALYSIS, the entire disclosure of which is incorporated by reference herein.

### TECHNICAL FIELD

The present invention relates to a system and method that can be used in reliability centred maintenance analysis, although the invention is potentially also suitable for use in (or as part of) other forms of asset analysis as well.

### BACKGROUND

Reliability centred maintenance analysis (RCM) is a form of analysis that can be used for analysing and recommending or determining a maintenance and/or operational strategy for an asset or system. RCM can also be used for a range of other purposes, such as for optimising spare part holdings, optimising logistics processes, etc. RCM was originally developed within the aircraft industry, and was later adapted for use in several other industries and branches of the military, and it provides a process that can be used to preserve asset or system function, identify failure modes that can affect an asset or system (i.e. by preventing or interfering with the ability of the asset or system to perform its required function), prioritise the failure modes, and select applicable and effective tasks and strategies to control the failure modes.

RCM analysis is traditionally performed by a team that includes at least one subject matter expert having expertise in relation to the asset or system in question, its operating context and its environment, and also at least one RCM expert. The team analyses the functions which the asset or system is to perform, the potential functional failures that could affect the function(s) of the asset or system, and the failure modes that could cause such functional failures, in order to develop, for example, scheduled maintenance plans, operational plans, intervention plans, inspection plans, or the like, that will provide an acceptable level of (or an acceptable balance between) operability and risk for the asset or system in question in an efficient and cost-effective manner.

A problem with the way RCM processes are traditionally performed (i.e. in the prior art) is that they are time consuming, labour intensive and very costly. In particular, for a single physical asset, it may take hours or even days for the team of people involved (often in a meeting or workshop setting) to perform the RCM analysis for that single asset and thereby determine, optimise and implement the strategies identified through the analysis. Accordingly, when this traditional way of performing RCM processes is applied to, for example, an entire facility comprising many assets (e.g. a mine or a factory), it can sometimes take a very long time (potentially years) to fully implement RCM across the facility.

Furthermore, the quality of the results of an RCM process depends on the quality of the inputs, including the input from subject matter experts and RCM experts. As such, simply reducing the time spent on a traditional RCM process (i.e. by simply devoting less time to it) will generally result in lower quality results from the process, and in turn the quality or benefit of the maintenance or operational program (or the like) is likely to be reduced as well.

Also, it is important to recognise that identical assets, but which are used in different environments or operational contexts, can have vastly different operating and maintenance requirements due to factors such as varying consequences of failure in different environments or operational contexts, differing duty, differing maintenance and/or operational requirements in different environmental conditions, etc. This means that RCM models for assets are rarely reused and instead are often created (i.e. completely anew or “from scratch”) for individual assets or systems (or components thereof), each time, for the specific operating context and environment in question, but this is time consuming and costly, and it potentially also requires new input from subject matter experts and/or RCM experts on each occasion.

A further problem with the way RCM processes are traditionally performed (in the prior art—see above) is that changing circumstances, or changes to things like the operating conditions for, or the operating status of, the asset in question, may render invalid or suboptimal some or all of the maintenance or operational strategies (or the like) previously identified or put in place for that asset as a result of the previous RCM process, and this can therefore require significant rework, again possibly including further input from subject matter and/or RCM experts, which is again time consuming and costly.

It is to be clearly understood that mere reference in this specification to any previous or existing products, systems, methods, practices, publications or indeed to any other information, or to any problems or issues, does not constitute an acknowledgement or admission that any of those things, whether individually or in any combination, formed part of the common general knowledge of those skilled in the field or is admissible prior art.

### SUMMARY OF THE INVENTION

The present invention is directed to systems and methods which, it is hoped, may at least partially overcome one or more of the abovementioned disadvantages or provide a useful or commercial choice or option in the marketplace.

It should also be noted, however, that although the Background section above refers to reliability centred maintenance analysis (RCM), and although the present invention is described below often with reference to its use in (or as part of or associated with) reliability centred maintenance analysis (RCM), the invention is not necessarily limited to use in (or with or as part of) RCM, and the invention can potentially also be used in (or as part of or associated with) other forms of asset analysis such as, for example, remaining asset life analysis, asset operational strategy optimisation, asset or equipment selection, etc.

With the foregoing in view, the present invention, in one form, resides broadly in a system for use in asset analysis including:

one or more asset type models, each asset type model relating to multiple individual (possible) assets having common characteristics and applications; and

a governance framework for each asset type model, the governance framework being configured or operable to convert the asset type model into a specific asset model corresponding to a specific asset, the specific asset having a particular condition and operating in a particular operational context and environment,

wherein

an asset type model is converted into a specific asset model for a specific asset based on a plurality of decisions defined by the governance framework for that asset type model,

the specific asset model is usable in (or as part of) a further analysis associated with the specific asset (e.g. a reliability centred maintenance analysis (RCM) associated with the specific asset, or a remaining life analysis associated with the specific asset, etc), and

the decisions defined by the governance framework for an asset type model are made according to input and/or known data or information relating to, and any specific asset model created using that asset type model therefore contains information about, one or more of the following: the specific asset itself (e.g. its nature and configuration, its operational requirements, etc), the condition (or current condition) of the specific asset, the operational context in which the specific asset operates; and the environment in which the specific asset operates.

Advantageously, the way the system enables an asset type model to be converted into a specific asset model for a specific asset by employing a governance framework (which defines a plurality of decisions) provides a simple and efficient means to generate specific asset models for specific assets, such that these specific asset models may in turn be used, for example, as part of a reliability centred maintenance analysis for the specific asset, e.g. to generate maintenance plans, operational plans, intervention plans, risk, budgetary and resource information, and the like, for the specific asset. The specific asset models produced by the system may also (or alternately) be used in (or as part of) other forms of asset analysis, such as, for example, remaining asset life analysis, asset operational strategy optimisation, asset or equipment selection, etc.

Also, unlike the traditional way in which RCM processes are undertaken (see the Background section above), the present system (and the use of the system) may reduce or even remove the need for RCM experts and/or subject matter experts each time there is a need to create a specific asset model for a specific asset. It should be noted, however, that although the system may reduce or remove the need for involvement by RCM and subject matter experts each time a specific asset model is to be created for a specific asset to enable analysis to be performed on (or associated with) the specific asset, subject matter and/or RCM experts will generally still be required to provide input in the development of the asset type models and/or the governance frameworks (for respective asset type models) from which the specific asset models are created using the system.

The system may also have the additional benefit of enabling asset models to be updated and improved over time, and the system may make this much easier to achieve than has previously been possible. This is because the asset type models and the governance frameworks used in the system can be updated with new information or insights (e.g. from subject matter or RCM experts), and/or with newly acquired or additional data obtained for a specific asset, or for multiple different assets within a single class or “type” of asset, which can then be used to update the asset type models and/or the governance frameworks in order to improve the quality of any specific asset models produced using the system in the future. The significance of this will be appreciated when it is considered that, even within a particular industry, the present system may be used by numerous organisations in that industry, and many or all of the different organisations may provide the new information or data they have acquired (or that they acquire progressively) to update the asset type models and/or the governance frameworks, and so the potential for gathering new insights and/or data for use in improving future specific asset models generated by the system, and also the speed at which this may be done, is far greater than if each individual organisation were to attempt to improve its own RCM models based only on its own internal learnings and data.

An asset type model may be converted into a specific asset model for a specific asset at least in part by including, excluding/removing or otherwise modifying a part or item or attribute or feature included in the asset type model. One or more relevant parts or items or attributes or features of an asset type model may therefore be selected for use in (and to form part of) a specific asset model for a specific asset.

An asset type model may comprise, in effect, (or it may be thought of as) a superset of all possible specific asset models for assets of a particular type, and an asset type model may be converted into a specific asset model for a specific asset by removing parts or items included in the asset type model according to decisions of the governance framework applicable to that asset type model.

The governance framework for a given asset type model may be configured or operable to convert the asset type model into a specific asset model for a specific asset (of the “type” to which the asset type model relates) by one or more of: adding or removing a part or item of the asset type model (e.g. adding or removing a component); setting a failure characteristic of the asset (this may include things like setting an estimated life and failure offset for the asset, or other failure characteristic for the asset); modifying a failure characteristic of the asset based on the condition of the asset (this may be done progressively or repeatedly or even continuously over time); and setting a task associated with a component or the asset.

The governance framework associated with an asset type model will, in most embodiments, comprise a plurality of questions and/or data inputs, and one or more actions may be performed on the asset type model according to information provided in the answers to the questions and/or in the data inputs.

Preferably, some of the questions, and more preferably, all of questions, in the governance framework associated with an asset type model, may each have a plurality of predefined answers, and there may be one or more actions associated with different combinations of different predefined answers being provided to different questions.

An asset type model may comprise a plurality of components, and a specific asset model created using the asset type model may often include only a subset of the plurality of components included in the asset type model.

Each component may be associated with one or more functions. Each function may be associated with one or more functional failures, and each functional failure may be associated with one or more failure modes.

The system may operate so that questions are provided (optionally interactively) to a user, and as the user responds to the questions, the asset type model is dynamically updated or modified so as to ultimately be converted into a specific asset model for the specific asset under consideration by the user once all questions have been answered.

The system may function so that asset type models are selectable by a user (i.e. the system may enable a user to select a desired asset type model, possibly from amongst multiple different asset type models related to different asset types).

Optionally, the system may also be configured to analyse the specific asset model, that is, to undertake some form of analysis on the specific asset model created by the system from the asset type model, and to display results of the analysis. As an example, the system may be configured to perform a reliability centred maintenance analysis (RCM) based on a specific asset model that has been created by the system, and in this case the system may also be configured to analyse and display details of one or more of the following (for example) for the specific asset: a maintenance plan, an operational plan, an intervention plan, an inspection plan, risks, budgetary and resource information associated with any of these plans, expenditure over time, probability of failure over time, a list of failure modes, overlap min and max bounds for probability and/or cost, etc.

The system may be configured to generate one or more outputs based upon the analysis. The outputs may include one or more of: a failure mode, effects and criticality analysis (FMECA); a list of tasks; a probability of failure; cost data; and a dashboard. The system may be configured to automatically determine a strategy for operation, maintenance and end of life tasks for each asset. Such determination may be in accordance with one or more constraints imposed by the user or owner or operator of the specific asset, such as technical or economical limitations. Similarly, the generation of outputs may be automated according to information such as labour, spares, resource and consequence costs, as well as other statistical probabilities of events.

The system may be configured to create specific asset models for, and possibly then perform asset analyses on, a plurality of specific assets (i.e. at the same time). The plurality of specific assets (i.e. the details related to them, needed to create the specific asset models) may be bulk uploaded or loaded into the system in a file, or details may even be provided to the system as a live or real-time feed from another system. The different specific assets may be associated with one or more asset type models. Where the system operates to perform analyses on the plurality of specific asset models created, the outputs of the analyses may also be provided live or in real-time.

The system may be configured to enable the governance framework and/or the asset type models to be updated. The outputs (whether these outputs are the details of the specific asset models created by the system, and/or whether the outputs of any analyses performed on the specific asset models) may be configured to be automatically re-generated based upon updates to the governance framework and/or the asset type models. The outputs may be configured to automatically re-generate based upon, for example: updates to condition assessments, consequences costs or the likelihood thereof, business parameters, and operating benefits. The term “operating benefits” here refers to the differing benefits that may flow from operating the specific asset in different ways. For example, a specific asset operating at 80% utilisation may achieve a given throughput (X) and may have a relativity low likelihood of failure. However, operating the same asset at 110% utilisation may cause the asset's throughput to increase by an amount (Y) (i.e. such that the asset's throughput becomes X+Y), but the asset may also be more likely to fail. Consideration of such different “operating benefits” (i.e. trade-offs associated with different ways of operating the asset) may enable maintenance plans (and the like) to be proposed that consider the flow on effects of how an asset is operated over and above simply the likelihood of failure, and the costs associated with maintenance.

The system may be configured to receive data or information from multiple sources, and/or at multiple points in time (or continuously or “live”), and to update the governance framework for one or more asset type models based upon the data. The received data may be weighted. The data may be weighted at least in part according to sample size.

In another form, the invention resides broadly in a method for use in asset analysis, the method comprising:

providing one or more asset type models, each asset type model relating to multiple individual (possible) assets having common characteristics and applications;

providing a governance framework for each asset type model, the governance framework being configured or operable to convert the asset type model into a specific asset model corresponding to a specific asset, the specific asset having a particular condition and operating in a particular operational context and environment, and

enabling a user to convert an asset type model into a specific asset model for a specific asset based on a plurality of decisions defined by the governance framework for that asset type model,

wherein

the specific asset model is usable in (or as part of) a further analysis associated with the specific asset (e.g. a reliability centred maintenance analysis (RCM) associated with the specific asset, or a remaining life analysis associated with the specific asset, etc), and

the decisions defined by the governance framework for an asset type model are made according to data or information that is input by the user, and/or known, relating to, and any specific asset model created using that asset type model therefore contains information about, one or more of the following: the specific asset itself (e.g. its nature and configuration, its operational requirements, etc), the condition (or current condition) of the specific asset, the operational context in which the specific asset operates; and the environment in which the specific asset operates.

Any of the features described herein can be combined in any combination with any one or more of the other features described herein within the scope of the invention.

### BRIEF DESCRIPTION OF THE DRAWINGS

Features, embodiments and variations of the invention may be discerned from the following Detailed Description which (especially when considered with the Background and Summary of the Invention above) provides sufficient information for those skilled in the art to perform the invention. The Detailed Description is not, however, to be regarded as limiting the scope of the preceding Summary of the Invention in any way. The Detailed Description below makes reference to the accompanying drawings, in which:

FIG. 1 schematically illustrates a system (including system architecture) for use in asset analysis according to an embodiment of the present invention.

FIG. 2 is a schematic representation of an asset type model in an embodiment of the present invention.

FIG. 3 is a schematic representation of a governance framework in an embodiment of the present invention.

FIG. 4 is a schematic representation of a specific asset model in an embodiment of the present invention.

FIG. 5 shows a screenshot from a system according to one possible embodiment of the invention, and more specifically it shows a screenshot of a screen from which a user can select an asset type model corresponding to one asset “type” from amongst a number of asset type models relating to a number of different asset “types”.

FIGS. 6-15 show screenshots which, when viewed in conjunction with the associated descriptions below, provide an example illustrating the operation of the system in FIG. 5.

FIG. 16 shows a screenshot from a system according to another possible embodiment of the invention.

### DETAILED DESCRIPTION

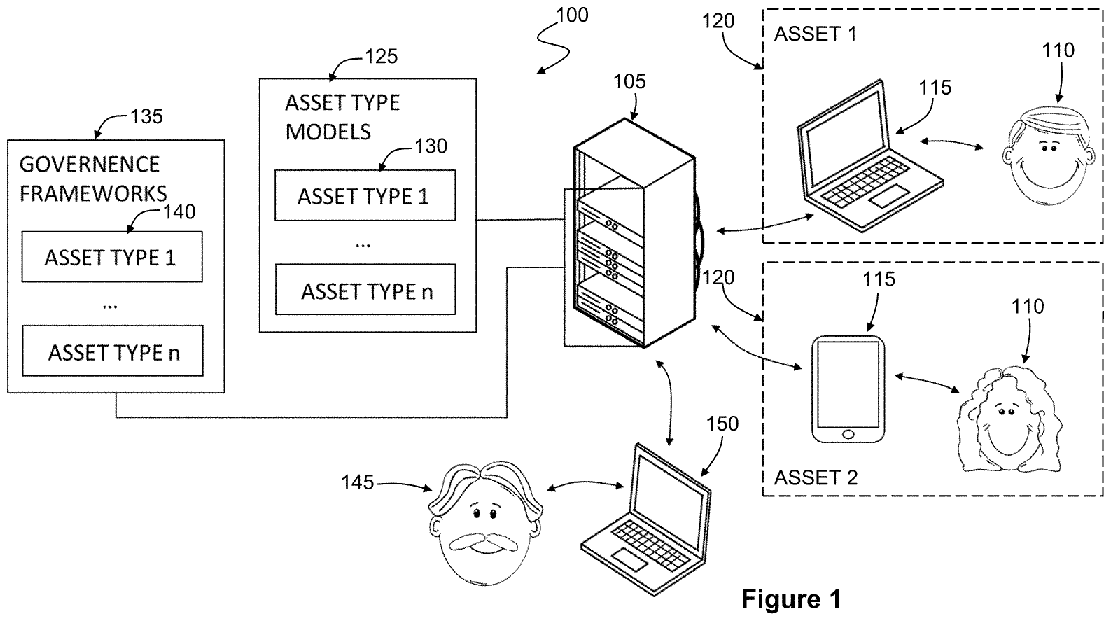

FIG. 1 schematically illustrates the architecture of a system 100 for use in asset analysis according to one possible embodiment of the present invention. The system 100 includes generic asset type models (rather than specific asset models for individual/specific assets) and a governance framework, and the governance framework is used to convert an asset type model into a specific asset model for a specific asset based on a number of decisions defined by the governance framework. The system 100 provides a simple and efficient means to generate a specific asset model for a specific asset, and the specific asset model thus obtained can be used in (or as the basis for) a further analysis of the specific asset (i.e. the particular asset in question). For example, a specific asset model created using the system might be (and often will be) used as the basis for a reliability centred maintenance analysis (RCM) for the purpose of determining things like e.g. a maintenance plan, operational plan, intervention plan, inspection plan, etc, for the specific asset. Alternatively, a specific asset model created using the system may be used as the basis for some other kind of analysis of the specific asset, such as a remaining asset life analysis, or asset operational strategy optimisation, etc.

The architecture of the system 100 (in this embodiment) includes a central server 105 with which one or more of users 110 may interact using respective user computing devices 115 to create a specific asset model for a specific (or particular) asset 120. Note that, in FIG. 1, two specific assets 120 are represented, namely ASSET 1 and ASSET 2. However, whilst a user 110 who uses the system to create a specific asset model for the specific asset is shown for both ASSET 1 and ASSET 2, and for each user 110 a user computing device 115 is shown which the relevant user can use to create the specific asset model for the relevant specific asset, the specific asset itself (and its type and nature) is not shown or indicated for either ASSET 1 or ASSET 2. Accordingly, ASSET 1 and ASSET 2 could both be any kind of specific asset whatsoever, like e.g. a particular electric motor, or a particular computer, or a particular pressure vessel, or a particular pump, or a particular power pole, or a particular transformer, or a particular piece of excavating equipment, or indeed any kind of specific asset whatsoever, and ASSET 1 need not be the same kind of asset as, or even related in any way to, ASSET 2.

As mentioned above, a specific asset model for a specific asset 120 created using the system 100 may then be used in (or as the basis for) a further analysis of the specific asset 120, for example, a reliability centred maintenance analysis (RCM) of the specific asset 120, or a remaining asset life analysis, or an asset operational strategy optimisation, etc, for the specific asset 120. Use of the system 100 alleviates the need for RCM and subject matter experts in the creation of a specific asset model for a specific asset 120, and as such, the users 110 need not have particular expertise in either area, and may, for example, be administrative (or non-expert) staff working with or associated with the asset 120 for which the specific asset model is to be created.

The server 105 includes a data store 125 comprising (or containing), in this embodiment, a plurality of asset type models 130. Each asset type model 130 describes (or relates to) an asset “type”, where there are multiple different possible specific assets of that asset “type” (i.e. of the “type” to which the particular asset type model 130 relates), and where all possible specific assets falling within a particular asset type model have common characteristics and applications. Therefore, unlike traditional RCM models which define a model for a specific (i.e. an individual) asset only, and only in a particular operational and environmental context, in contrast, the asset type models 130 in the system in FIG. 1 (and in the invention generally) each relate to a “type” (i.e. a set or a class) of assets having one or more common characteristics. More specifically, each asset type model 130 comprises a combination of (or it incorporates) all features and attributes of an asset and its components, all conditions (in the sense of things like how worn or how used it is, etc) of an asset and its components, and all external operational and environmental contexts in which the asset may operate, such that a specific asset model for a specific asset (being an asset of the “type” to which the asset type model relates), which is operating in a particular operational and environmental context, can be created based on all of the possible combinations and permutations of these things contained or included within the relevant asset type model.

As an example (which is vastly simplified but nevertheless useful for illustrative purposes here), an asset type model 130 could exist for which the asset type is “computer”. A particular laptop computer would be one possible specific asset falling within the asset type “computer”, and a particular desktop computer would be another possible specific asset falling within the asset type “computer”. A laptop and a desktop computer, while different in some ways, clearly have many common characteristics and thus both fall (in this simplified example) within a common asset type model. Thus, an asset type model 130 for the asset type “computer” would comprises a combination of (or it would incorporate) all features and attributes of different specific forms of computer and their components, all conditions (in the sense of things like how worn or how used it is, etc) of different specific forms of computer and their components, and all external operational and environmental contexts in which different forms of computer may operate, such that a specific asset model for a specific asset (i.e. a specific computer), which is operating in a particular operational and environmental context, can be created based on all of the possible combinations and permutations of these things contained or included within the relevant asset type model 130 for the asset type “computer”.

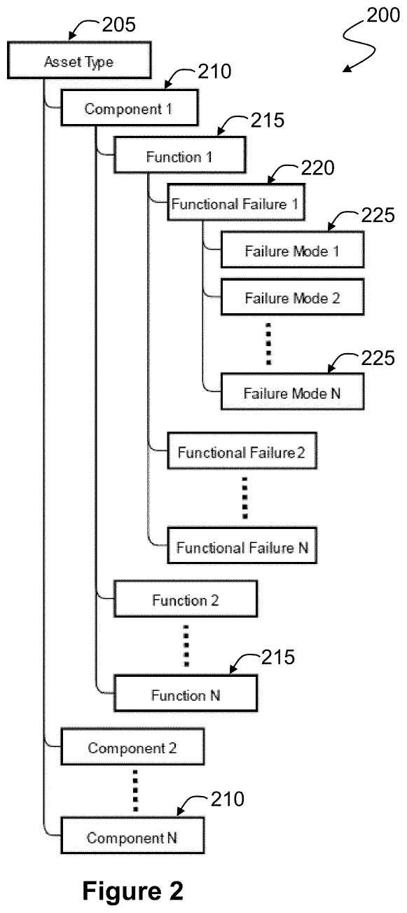

FIG. 2 is a schematic representation of an asset type model 200. The asset type model 200 in FIG. 2 may be similar or identical to (i.e. it may correspond to) one or each of the asset type models 130 represented in FIG. 1.

The asset type model 200 refers to a (normally physical) asset type 205 having a plurality of components 210. In the simple illustrative example mentioned above in which the asset type is “computer”, “computer” would therefore be the asset type 205, and examples of components 210 that could form part of different specific assets falling within the general class or “type” of asset “computer” could include, e.g., a built-in keyboard (this would apply to laptops) or an external keyboard (this would apply to desktop computers but possibly also to laptops and even tablet computers), an internal mouse (this would apply to laptops) or an external mouse (this could apply to both laptops and desktops), a battery (this would apply to laptops), a hard drive (this would apply to both laptops and desktops), etc. It is important to note that the components 210 included within (or forming part of) an asset type model 205 will generally focus on those components for which a failure thereof would cause disruption to, or prevent, the operation of the asset, i.e. in the above simple “computer” example, the components would be those components for which, if one or more of them were to fail, the ability to use the computer (whether it be a laptop or desktop or other form of computer) would be disrupted or prevented.

Each component 210 is associated with one or more functions 215. Continuing to refer to the above simple “computer” example, an example of a function of the component “battery” would be to power the laptop (it will be appreciated that the component “battery” would not be included in any specific asset model associated with a desktop computer because desktop computers do not generally require a battery). Each function 215 is, in turn, associated with one or more functional failures 220, and each functional failure is further associated with one or more failure modes 225. An example of one possible functional failure 220 that might be associated with the component “battery” is that the battery becomes inoperable, and examples of possible failure modes 225 associated with (i.e. which may cause) this functional failure include e.g. mechanical shock (e.g. due to an impact to the laptop or its battery), overheating, etc.

Some or all failure modes 225 may be associated with tasks, which are in turn associated with resources and costs. Each failure mode 225 may also be associated with consequences, which are in turn associated with costs. Finally, each failure mode 225 may be associated with one or more failure characteristics.

The server 105 in FIG. 1 also includes a data store 135 including governance frameworks 140; specifically (in this embodiment) a governance framework 140 associated with each respective asset type, and thus there is (in this embodiment) a governance framework 140 for each asset type model 130. A governance framework 140, when applied to (or used in conjunction with) the asset type model 130 to which it relates, enables the generation of various specific asset models for the various possible specific assets of the “type” of asset covered by that asset type model. As outlined in further detail below, the governance frameworks 140 define decisions which determine which parts of an asset type model 130 are relevant to a particular/specific asset, and this is used to adapt the asset type model to generate (or arrive at) the specific asset model.

Each decision is typically made based on one or more questions, each question having multiple or a range of possible acceptable answers, and there will typically be one or more actions that are to be performed on the asset type model 130 (i.e. one or more ways in which the asset type model 130 is to be adapted in order to convert it into a specific asset model for the specific asset in question) based on various decisions (i.e. based on the answer(s) selected or provided in response to one or more of the question(s)). It is important to note that, often, it may not simply or always be the case that one answer to a particular question necessarily leads to one action and that a different answer to the same question necessarily leads to a different action. That is, there may not always be a simple 1:1 relationship between a given question/answer and a given action. It may often be more complicated than this. For instance, a single action may be associated with a combination of decisions. In other words, there may be a combination of decisions, or even a range of different possible combinations of different decisions, that may prompt or cause a particular action or combination of actions. Consider, for example, calculating the decay rate of wood (e.g. for the purposes of estimating the expected life of a particular part of a specific asset that is made of wood). This wood decay rate calculation is necessarily based on multiple decisions e.g. the type of wood, the environment, wood treatment, etc. The answers to these questions can then be provided or fed into an algorithm that calculates a single value i.e. the rate of decay for the particular wooden part in question. That decay rate may then be further combined with other decision answers, such as e.g. the wood thickness, to ultimately prompt an action, e.g. change the expected life of the wooden part to X.

Thus, a particular action (or a particular combination of actions) may be caused based on a combination of answers given to multiple different questions, and there may even be different combinations of answers to different combinations of questions that can lead to the same action(s) being taken. Also, it may sometimes be that answers to questions (or combinations of answers to different questions) may require the information (or the combination of pieces of information) provided in that/those answers to be further processed in some way (e.g. fed into an algorithm, or the like) in order to arrive at a decision (or decisions) or to provide or determine the action(s) required based on that/those answer(s). The wood decay rate calculation above is an example of this. In any case, ultimately, the decisions (which are in turn based on the answers to the various questions, considered in combination) become a mechanism for capturing contextualised knowledge and information relating to the specific asset in question (for which a specific asset model is required to be created), and the actions required based on those decisions when considered in combination, are used to form the specific asset model for that specific asset in question. It will be understood that the way in which the governance framework determines what actions to take in response to different combinations of decisions is generally based on subject matter expert and RCM expert input (i.e. based on their expertise) that is provided and built or programmed or coded into the system. This expertise which is built or coded into the system (into the governance framework) is obviously important to the operation of the system, but this (i.e. the particular expertise provided by the subject matter experts and RCM experts, and the way this is built or coded into the system) is not the focus of the present invention. Rather, the focus of the present invention is providing a system that contains one or more asset type models and a governance framework (incorporating the built- or coded-in expertise of the experts) for each asset type model, and which can (crucially) therefore be used to create a specific asset model much more easily and quickly than has previously been possible (and without necessarily requiring input from experts each time a specific asset model is to be created).

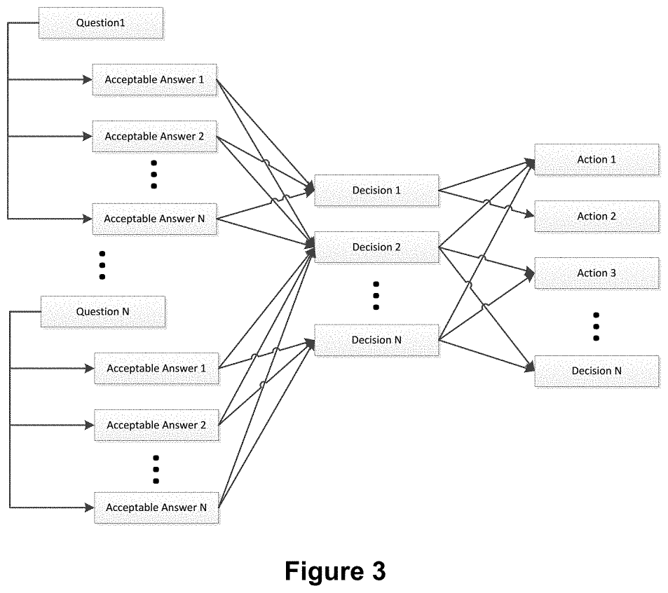

The diagram shown in FIG. 3 is an attempt to represent the governance framework described above schematically. However, it will be understood that the schematic representation in FIG. 3 is not necessarily a perfect or accurate representation of the nature of the relationships between the questions, acceptable answers, decisions and actions applicable in all cases, because the nature of these relationships is often far more complex than can be represented simply by connecting lines or arrows in a block diagram. For instance, the diagram in FIG. 3 may not be representative of governance frameworks applicable in all situations because, for example, in FIG. 3, all decisions are connected by arrows to all of the acceptable answers to all of the questions, thus suggesting that every decision is related to (or dependent in some way upon) every possible answer to every question. This may not always be the case. For example, there may often be a number of decisions that do not relate to (or depend in any way upon) the answer given to a particular question or questions (i.e. a decision may depend only on the answer given to other questions). Similarly, in FIG. 3, all actions are connected by arrows to all of the decisions, thus suggesting that every action is related to (or dependent in some way upon) every decision. This also may not always be the case.

The governance frameworks 140 may accept decision information in a host of formats and it may pose questions in a variety of ways. For example, a question may simply provide an input field for input of data in answer to the question, e.g. by entering numerical data such as a typical operating temperature of an asset or a component thereof, or the like. An acceptable answer may also be sourced from some other external source (rather than being manually input by the user), such as, for example, from an external file or external database, or from another or a separate software package e.g. an Enterprise Resource Planning (ERP) tool, etc. A question might further provide a drop-down menu from which a user can select an answer from among a list of acceptable answers. Also, it may often be the case that providing a particular answer to one question may automatically determine or force the answer to one or more other questions, or prevent one or more other questions from being asked/presented (this is part of the way in which the system operates to convert an asset type model into a specific asset model for a specific asset).

The governance frameworks 140 discussed above therefore define relationships between questions and a plurality of, or a range of, acceptable answers, and they also define relationships between the one or more acceptable answers and one or more actions based thereon, as discussed above. Each question represents a piece of relevant information required to adjust the asset type model in some way, and the way the system only permits acceptable answers ensures consistency and provides governance on how the asset type model is used (i.e. how it is adapted) by limiting the answers to only those which have a configured effect. The actions represent the effect(s) that the associated answers (considered in combination) have on the asset type model, and can be used to include, exclude or otherwise modify any part of the asset type model to arrive at a specific asset model.

An asset type model may comprise, or at least it may be thought of as representing, a “superset” of all possible components that may form part of any of the possible specific assets of the relevant asset “type”, and through use of the system, components are removed from the asset type model if they are not relevant (this is done by the governance framework, based on the answers to questions, etc, as described above), to thereby remove from the “superset” any components not relevant to the specific asset in question, in order to ultimately arrive at a specific asset model containing only components relevant to the specific asset in question. In other words, the actions may be thought of as removing components from the asset type model to arrive at the specific asset model. However, conceptualising the governance framework as operating in this way (or as only operating in this way), is not necessarily entirely accurate. In some instances, components may be added or adapted (and not simply removed) in response to questions.

Referring again to the simplified “computer” example above, one of the questions associated with an asset type model for computers might be “what type of computer is it?”, where the acceptable answers available to the user to select may be “laptop” and “desktop”. If the answer is “desktop”, actions that may follow from this may include: adding to the model an external monitor (component), an external mouse (component) and an external keyboard (component); setting inoperability of the CPU as one possible functional failure (among other possible functional failures); setting overheating of the CPU due to blockage or breakage of the CPU cooling fan as one failure mode (possibly among many) associated with the inoperability of the CPU functional failure: and including a task to inspect and/or clean the CPU cooling fans (task).

In use of the system 100 in FIG. 1, a user 110 logs onto the server 105, for example using log in details such as a username and a password. As the system may include a large number (and a wide range) of asset type models covering a variety of industries, the user may be prompted to enter his or her industry to enable the asset type models available within the system to be filtered based thereon.

Examples of industries to which asset type models may relate include the oil and gas industry, the mining industry and the utilities industry. However, it will be readily appreciated that the system may potentially include asset type models relating to any industry or industry category.

Details of an asset, or possibly a plurality of assets at once, are then entered by the user into the system. This may be performed manually, or by loading or uploading a file (e.g. a spreadsheet or data file) including the details associated with the asset or multiple assets. If there are multiple assets (i.e. whose details are entered, uploaded or otherwise provided at once), the assets may be selected or ranked according to their importance, which may be based upon cost, health, safety, and/or any other importance factor.

Each asset is then associated with an asset type model. This again may be performed manually (e.g. through selection of the asset type model from a plurality of such models), or by having such details associated with the asset in a file (e.g. the spreadsheet).

Once the asset type selections are made, the user 110 is prompted with a plurality of questions that are associated with the asset type model. One or more of the answers may default to default answers in case the answer to a given question is not known by the user 110, and other answers may be required. Providing default answers (even if only to certain questions) may help to enable a specific asset model to be created even if a user is unable to answer (or does not know the answer to) all questions.

As the user responds to the questions, the asset type model is dynamically updated (e.g. items are added, removed and/or updated in the model). Accordingly, the model becomes more accurate and more specific the more the users answers the questions, and ultimately becomes a specific asset model relating to the specific asset, its operational context and its environment.

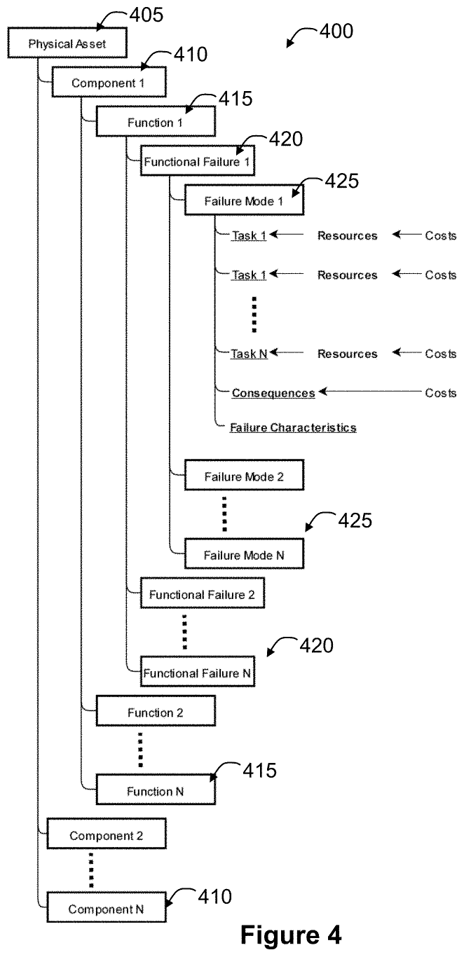

FIG. 4 is a schematic representation of a specific asset model 400. The specific asset model 400 may be similar or identical to a specific asset model generated by the system 100 of FIG. 1. Also, the specific asset model 400 is somewhat similar to the generic asset type models described above, because it is based upon such a generic asset type model, but has been adapted (according to a governance framework) based on details of the specific asset, its operational context and its environment.

The specific asset model 400 includes a physical asset 405, for which a plurality of components 410 are defined. The components 410 all correspond to components of the specific asset to which the specific asset model 400 relates. Each component 410 is associated with one or more functions 415. Each function 415 is associated with one or more functional failures 420, and each functional failure is associated with one or more failure modes 425. Each failure mode 425 is further associated with: one or more tasks, one or more consequences, and one or more failure characteristics. The tasks are each associated with resources and costs, and the consequences are associated with costs. Failure characteristics and the effects thereof can be altered by condition assessments.

In the case of a facility, more than one physical asset 405 may be defined. Similarly, components may be structured in a layered manner, such that components and sub-components are defined.

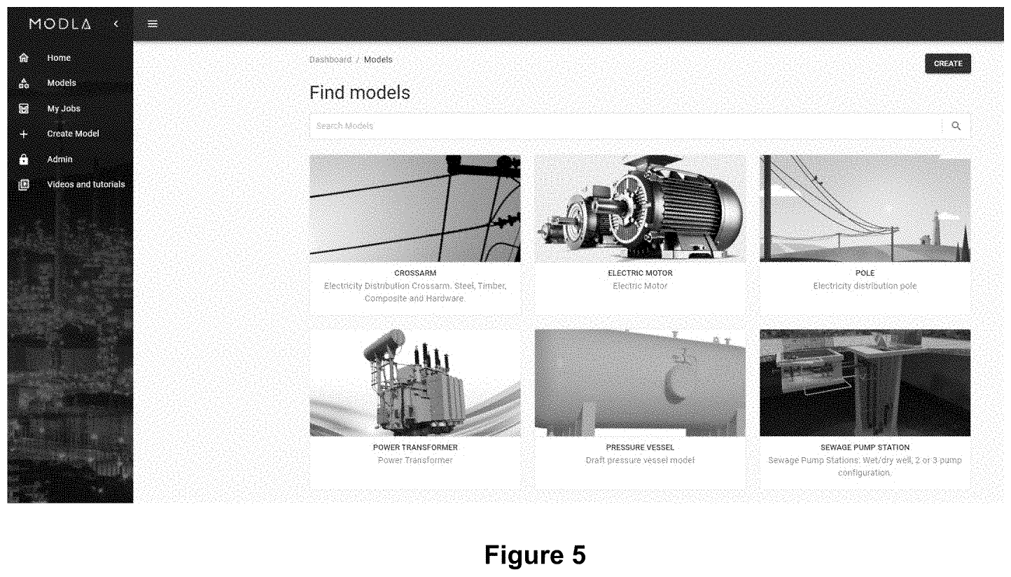

FIGS. 5-15 provide a partial but illustrative example of a typical process that a user may follow to generate a specific asset model for a specific asset, based on an asset type model, using one particular system (screenshots of which are shown in these Figures) which embodies the invention. It is important to note that, although the system to which these Figures relate also enables a user (or users, possibly in conjunction with subject matter experts and/or RCM experts) to create new (or modify) asset type models which can then be used by users to generate specific asset models for assets of a particular type, nevertheless FIGS. 5-15 and the explanations provided below with reference to them only consider the process involved in creating a specific asset model for a specific asset from one of the asset type models shown.

As can be seen on the left in FIG. 5, this system provides the user with a number of clickable options, namely (in this case): “Home”; “Models”; “My Jobs”; “Create Model”; “Admin”; and “Videos and tutorials”. The screenshot in FIG. 5 actually shows the screen in this system that is displayed when the user clicks on “Models”, and as can be seen in FIG. 5, this screen causes a collection or “library” of “Models” related to a number of different asset types to be displayed for selection by the user. More specifically, in FIG. 5, the “Models” (each of which is an asset type model) available for selection relate to the following asset types: “Crossarm” (being crossarms for power or utility poles); “Electric Motor”; “Pole” (being the vertical columns of power or utility poles); “Power Transformer”; “Pressure Vessel”; and “Sewage Pump Station”. As mentioned above, the icon for each of these “Models” (i.e. asset types) shown in FIG. 5 represents an asset type model, so clicking on one of these icons shown in FIG. 5 enables the user to begin the process of creating a specific asset model for a specific asset of the type selected.

Clicking on “Home” on the left-hand side in FIG. 5 causes the user to be returned to the system's main home screen. The “My Jobs” link provides the user with a link to any jobs that they have previously performed and saved. The “Create Model” link enables users (possibly together with subject matter and/or RCM experts) to create new asset type models (and any such newly created asset type model, once finished, would then be displayed as a new icon in the library of asset type models available for selection and shown in FIG. 5). The “Video and tutorials” link provides users with access to informative tutorials and other information about the system.

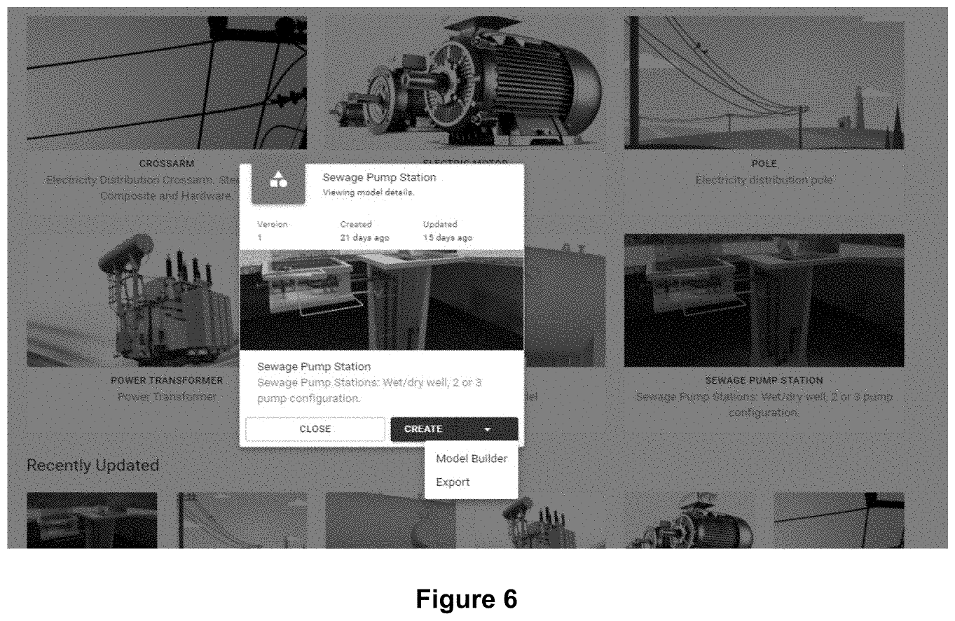

Thus, as just mentioned, as the first step, the user selects (i.e. clicks on the icon in the library in FIG. 5 for) the “Model” (i.e. the asset type model) for the asset type corresponding to the specific asset for which they wish to create a specific asset model. Turning to FIG. 6, this is a screenshot showing the screen displayed when a user clicks on the icon for the asset type “Sewage Pump Station” in order to begin preparing/creating a specific asset model for a particular sewage pump station. As shown in FIG. 6, after clicking on the icon for “Sewage Pump Station”, the user then has the option to click “Create”, and this is what is done to begin creating a specific asset model for the specific asset (a specific sewage pump station in this instance). However, as also shown in FIG. 6, the user also has the option at this point to “Export” a version of the model (for example in the form of a spreadsheet), and there is also a “Model Builder” option, which enables a user (or subject matter or RCM expert) to view and/or edit the underlying structure of the asset type model (and the governance framework) for the asset type “Sewage Pump Station”. For the purposes of this explanation, consideration will only be given to the creation of a specific asset model (i.e. for a specific sewage pump station in this instance), which is what happens when the user clicks on “Create” in FIG. 6.

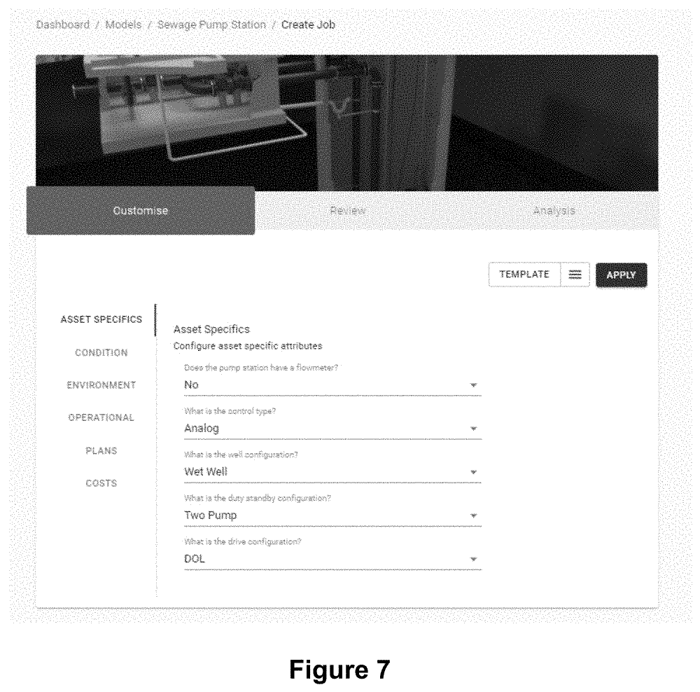

After clicking “Create” in FIG. 6 in order to begin creating a specific asset model (for a specific sewage pump station in this example), the user is then presented with a number of questions that must be answered so that the asset type model (for the asset type “sewage pump station” in this case) can be converted into a specific asset model for a specific asset (a specific sewage pump station). Screenshots showing the way in which the questions are presented, and the way in which they can be answered by the user, are shown in FIGS. 7-9. FIG. 7 also illustrates that in this part of the system there are three main tabs: “Customise”; “Review”; and “Analysis”. Everything under the “Customise” tab relates to the process of creating the specific asset model from the asset type model (i.e. by the user answering the questions posed by the system for the specific asset type selected). Under the “Review” tab, a user is able to review a specific asset model (e.g. after all questions required to create that specific asset model have been answered, in case the user wishes to go back and make one or more changes to the answers given to one or more questions under the “Customise” tab in order to modify/change that specific asset model). Under the “Analysis” tab, a user can run an asset analysis (e.g. a reliability centred maintenance analysis (RCM) or some other asset analysis) based on a specific asset model that has been created by answering all questions under the “Create” tab.

As shown in FIGS. 7-9, the questions presented by the system may be (and they are in this case) grouped under different screens or tabs according to what the questions relate to. Therefore, in the example shown (which relates to the questions presented in order to create a specific asset model for a specific sewage pump station), the questions are grouped into a number of tabs, namely questions relating to “Asset Specifics”, questions relating to the “condition” of the asset, questions relating to the “Environment” the asset will operate in, questions related to “operational” issues for the asset, questions related to “Plans” for how the asset may be operated or monitored or maintained (or the like), and questions related to “Costs” associated with the asset. It is important to note that, for other asset type models (associated with other asset “types”), there may be questions (or tabs containing questions) directed to other characteristics or factors or issues that may be relevant to those asset types, so these particular tabs (and the question is shown within them) on the left-hand side in FIGS. 7-9 are not exhaustive.

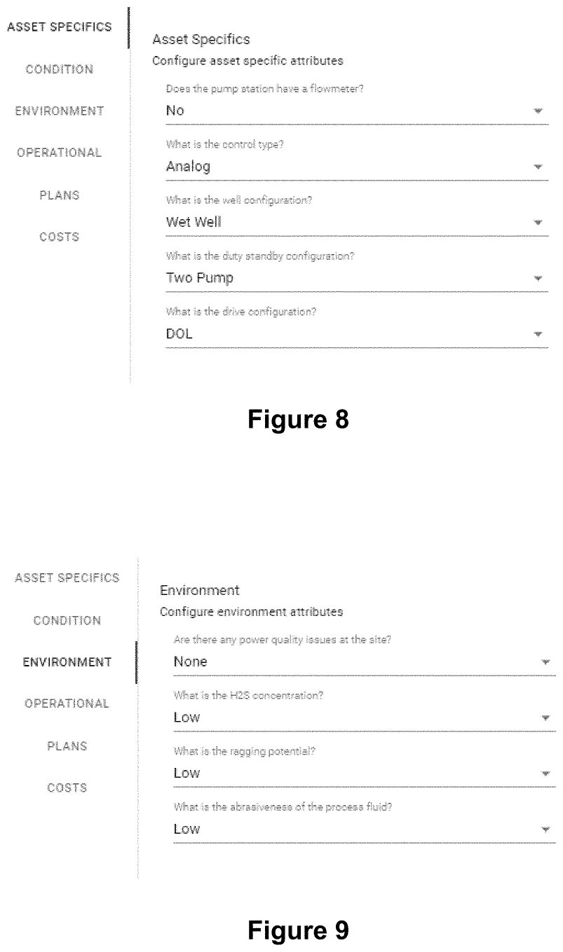

FIGS. 7 and 8 show the questions that are posed in the tab that relates to “Asset Specifics”. (Note: the questions shown in FIG. 8 are the same as those shown in FIG. 7, and in fact FIG. 8 is merely a portion of the screenshot that forms FIG. 7.)

In the system to which the present screenshots relate, a default answer to every question may be prefilled or populated by default. Of course, the user is able to change the answer to any question if the prefilled answer populated by default is incorrect or not the most appropriate. However, by providing a prefilled answer to each question by default, the system allows users with limited knowledge (i.e. who may not know the answer, or the most correct answer, to each question) to the nevertheless be able to use the system to create a specific asset model related to a particular asset type.

It can also be seen FIG. 7 that the user has the option to click on the “Template” button (shown in the top right). This is the option that allows users to provide or upload inputs (i.e. predetermined answers to all questions) for multiple (possibly thousands of) specific/unique assets at once, thereby enabling a huge number of different specific asset models for different/unique specific assets of a given asset type to be created at once and virtually instantaneously using the system. The benefits of this, compared to the traditional process for creating specific asset models one at a time as part of an RCM process (see the Background section above), will be readily apparent.

Turning now to FIGS. 8 and 9, FIG. 8 displays the questions (and the answers to those questions given in this example) under the “Asset Specifics” tab, and FIG. 9 displays the questions (and the answers to those questions given in this example) under the “Environment” tab. It is not necessary to discuss each of the questions, and the respective answer given, in FIGS. 8 and 9. However, for the purposes of the present example, it should be noted that, in the scenario depicted in these figures (this will be referred to as the first scenario), the specific asset model being created relates to a specific sewage pump station that:
does not have a flowmeter (because the answer to the question “Does the pump station have a flowmeter?” in FIG. 8 is “No”),
has a two pump duty standby configuration (because the answer to the question “What is the duty standby configuration?” in FIG. 8 is “Two Pump”)—it should be noted that in a two pump configuration, one pump is a standby pump, and
operates in an environment with low H2S (hydrogen sulphide) concentration (because the answer to question “What is the H2S concentration?” is “Low”)—it should be noted that H2S (hydrogen sulphide) is a poisonous and explosive gas, which may be present in the atmosphere in some environments (e.g. in oil and gas drilling and production facilities), and the presence of H2S can have an effect on the life of certain components by speeding up certain failure modes.

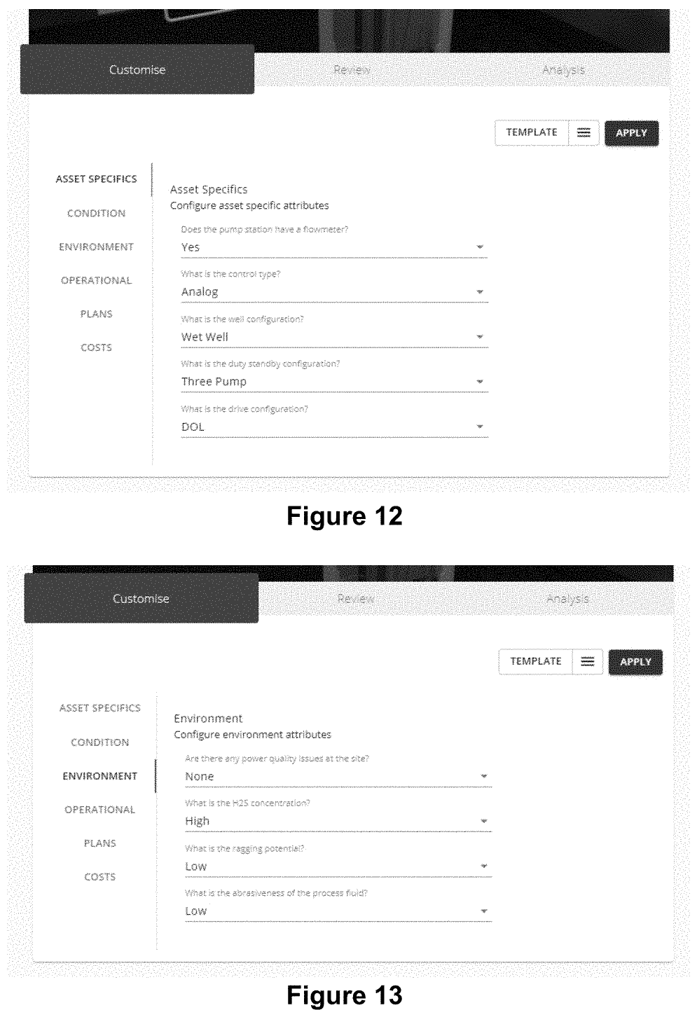

It is important to note the answers to these particular questions in FIGS. 8 and 9 (which relate to the first scenario), because in FIGS. 12 and 13 below the answers to these questions are changed (such that FIGS. 12 and 13 relate to a second scenario) in order to illustrate the effect of the changing the answers to these questions on the specific asset model created as a result.

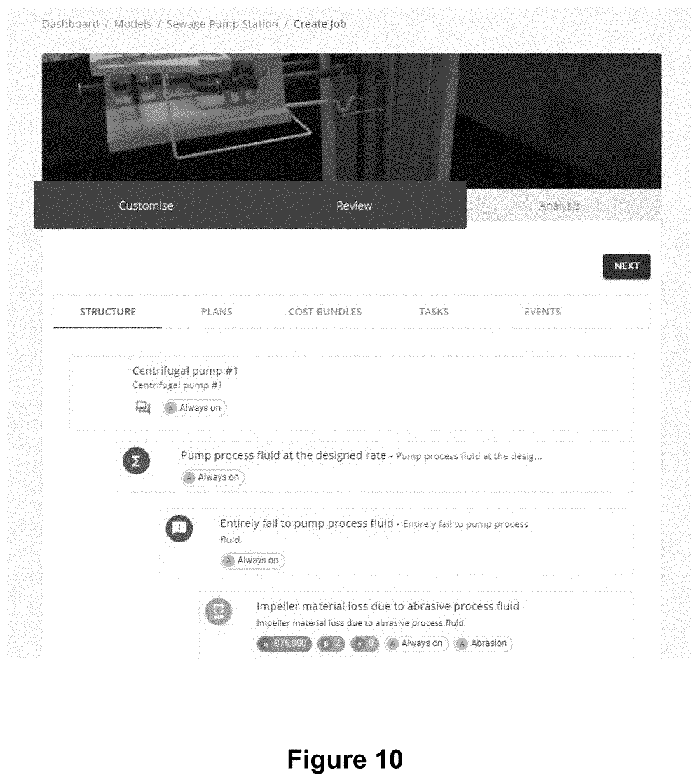

Turning now to FIG. 10, the partial screenshot shown in this Figure illustrates what the user can view by clicking on the “Review” tab at the top, after all of the questions under the “Customise” tab have been answers. As shown in FIG. 10, beneath the “Customise”, “Review” and “Analysis” tabs (and noting that it is the “Review” tab screen that is shown), there are a series of further tabs displayed horizontally, namely “Structure”, “Plans”, “Cost Bundles”, “Tasks”, and “Events” tabs. These tabs allow the user to view different components of the model, structure and how it has been affected by e.g., disabling components, changing failure modes, etc. Users can also review plans, cost bundles, tasks and events. Beneath the “Structure”, “Plans”, “Cost Bundles”, “Tasks”, and “Events” tabs in FIG. 10 there is shown a tree structure for a particular component (the component in this case is Centrifugal pump #1), and it will be noted that this tree structure actually corresponds to the tree structure shown in FIG. 4. In other words, in FIG. 10, the Centrifugal pump #1 corresponds to a component (e.g. like Component 1, 410) in FIG. 4. Similarly, the function of the centrifugal pump shown immediately underneath, namely to “pump process fluid at the designated rate” corresponds to a function (e.g. like Function 1, 415) in FIG. 4. Furthermore, the functional failure immediately underneath that, namely “entirely fail to pump process fluid” corresponds to a functional failure (e.g. like Functional Failure 1, 420) in FIG. 4, and the failure mode underneath that, namely impeller material loss due to abrasive process fluid, corresponds to a failure mode (e.g. like Failure Mode 1, 425) in FIG. 4.

A number of symbols and identifiers are displayed in FIG. 10, underneath the failure mode “impeller material loss due to abrasive process fluid”. These identifiers include η (eta), β (beta) and γ (gamma) identifiers, which describe the failure distribution applicable to the failure mode, and there are also other identifiers, in this case “Always on” and “Abrasion”. These latter identifiers determine which of the inputs have an effect on the different elements of the specific asset model shown. For example, the fact that the “Abrasion” identifier is shown underneath the “impeller material loss due to abrasive process forward” failure mode in FIG. 10 indicates that the effect of abrasion is one of the things considered as part of the governance framework in connection with that failure mode.

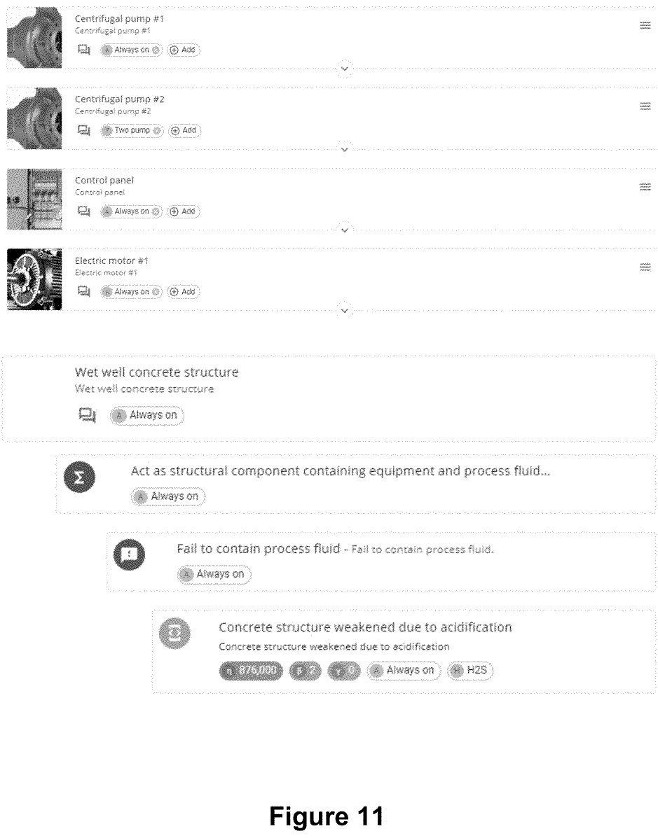

Turning now to FIG. 11 (which shows much of what was cut off the bottom in FIG. 10), in this Figure, the tree structure for Centrifugal pump #1 (which is shown expanded in FIG. 10) is collapsed, but other components of the specific asset model, such as Centrifugal pump #2, Control Panel and the Electric motor #1 are shown. Also shown in FIG. 11 is a tree structure for the component “Wet well concrete structure”. (Recall that the answer to the question “what is the well configuration?” in FIGS. 7 and 8 is “wet well”—that is what caused the wet well concrete structure to be a component of the specific asset model shown in FIG. 11.) It should also be noted in FIG. 11 that the q (eta) identifier (which relates to expected life) provides an indication of 876,000 hours, but this expected life is one thing that can be affected by the presence of H2S (hydrogen sulphide) in the environment, so the eta value would be expected to decrease if the H2S concentration in the environment were higher, and this will be demonstrated by FIGS. 12-14 below which relate to the second scenario.

FIGS. 12 and 13 are actually very similar to FIGS. 8 and 9 above in that they are screenshots of the same screens of the system. In fact, the only differences between FIGS. 12 and 13, and previous FIGS. 8 and 9, is that in FIGS. 12 and 13, the answers to certain questions have been changed (compared to FIGS. 8 and 9) so that in the second scenario depicted in FIGS. 12-13, the specific asset model now being created relates to a slightly different specific sewage pump station that:
does have a flowmeter (because the answer to the question “Does the pump station have a flowmeter?” in FIG. 12 is “Yes”)—this is opposite to the first scenario in FIG. 8 in which this question was answered “no”,
has a “three pump” duty standby configuration (because the answer to the question “What is the duty standby configuration?” in FIG. 12 is “Three Pump”)—this is different to the first scenario in FIG. 8 in which this question was answered “Two Pump”, and
operates in an environment with high H2S (hydrogen sulphide) concentration (because the answer to question “What is the H2S concentration?” in FIG. 13 is “High”)—this is different to the first scenario in FIG. 9 in which this question was answered “Low”.

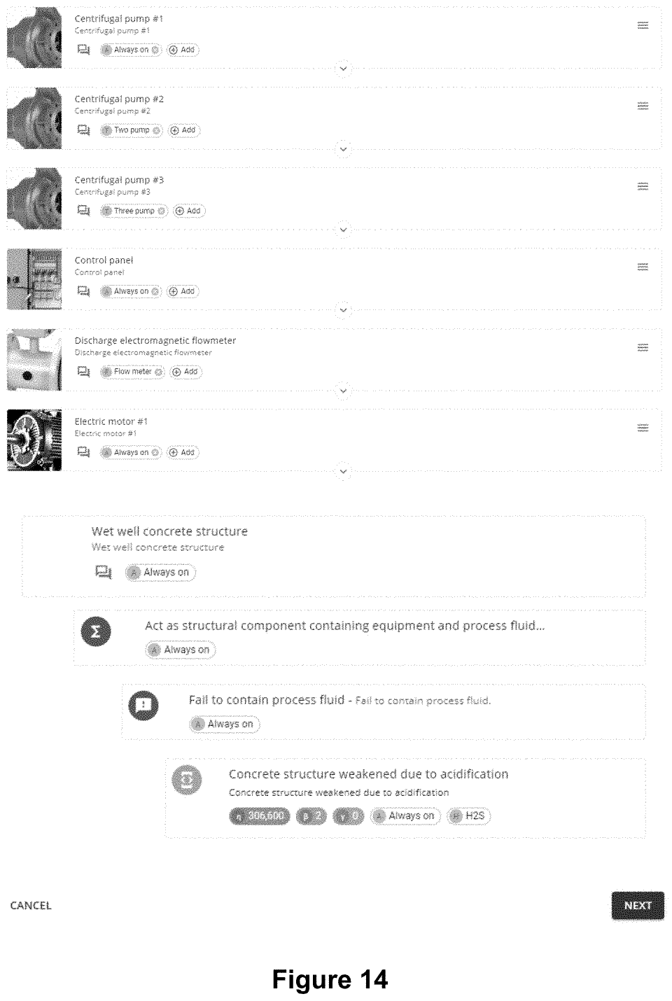

Turning now to FIG. 14, it will be appreciated that this Figure is similar to FIG. 11, in that both represent a specific asset model. However, there are differences between the specific asset model shown in FIG. 11 and the specific asset model shown in FIG. 14. This is due to the different answers to the various questions given in the first scenario versus second scenario. Therefore, the specific asset model shown in FIG. 11 relates to a different specific asset (i.e. at different sewage pump station) to FIG. 14 (which also relates to a sewage pump station but with differences compared to the one in FIG. 11). By way of further explanation, a comparison of FIGS. 11 and 14 shows that (and it should be evident in any case from the answers to the questions above) that the specific asset model for the specific sewage pump station in FIG. 11 has two centrifugal pumps (recall that it had a “Two Pump” configuration), whereas the specific sewage pump station in FIG. 14 has three centrifugal pumps (because it had a “Three Pump” configuration). Furthermore, unlike the specific sewage pump station to which the model in FIG. 11 relates (which has no flowmeter), the specific sewage pump station to which the model in FIG. 14 relates has a flowmeter (specifically a discharge electromagnetic flowmeter), as can be seen from the model in FIG. 14. Furthermore, the specific sewage pump station to which the model in FIG. 14 relates operates in a different environment to the specific pump station to which the model in FIG. 11 relates, and in particular an environment which has a higher hydrogen sulphide concentration, and a consequence of this can be appreciated by noting that the η (eta) value (which relates to expected life) shown in FIG. 14 under the failure mode “concrete structure weakened due to acidification” is reduced to 306,600 hours (compared to the much higher 876,000 hours in FIG. 11) due to this different operating environment.

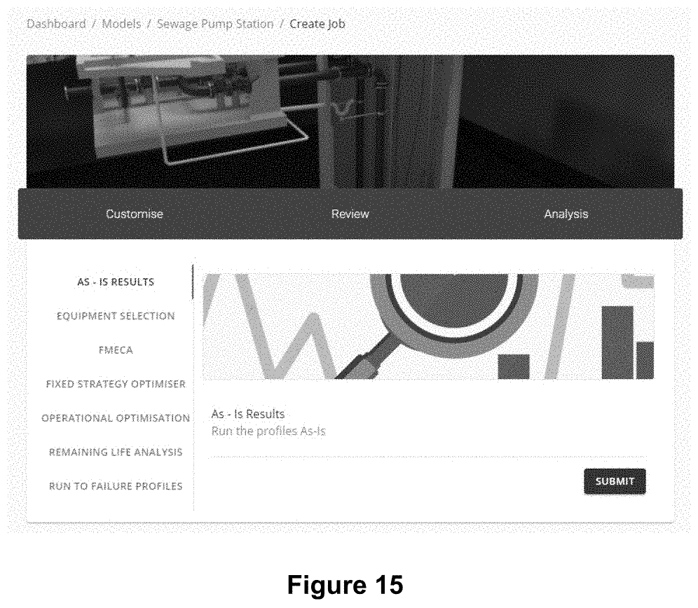

Turning now to FIG. 15, this Figure shows a screenshot of the screen displayed in this system when a user clicks on the “Analysis” tab. As explained above, when the user clicks on the “Analysis” tab, they can run an asset analysis (e.g. a reliability centred maintenance analysis (RCM) or some other asset analysis) based on a specific asset model created by answering all questions under the “Create” tab (i.e. after they have created a specific asset model in the manner described above). More specifically, FIG. 15 illustrates on the left-hand side the different options (in this example) for the different forms of analysis that the user can select to perform.

Returning now to FIG. 1, it will now be appreciated that, once a specific asset model has been generated, in some embodiments, the server 105 may be configured to subsequently analyse the model, and display results of the analysis. The kind or nature of the analysis performed once the specific asset model has been generated could be a reliability centred maintenance analysis (RCM), although it could also be any other kind of asset analysis. If the analysis that the server 105 is configured to subsequently perform is RCM, the server 105 may perform this analysis and display for the specific asset, for example: an optimised maintenance plan, an operational plan, an intervention plan, an inspection plan, an plan for expenditure over time (according to an optimised plan vs. run to failure), information on the probability of failure over time (according to an optimised plan vs. run to failure), a list of failure modes affected by default decisions (predominant failure modes as determined by related costs and 80/20 rule for optimised plan, for example), and overlap min and max bounds (probability and cost) produced by min and max sensitivity settings.

The user 110 may review these results, and when accepting of the results (i.e. no longer wanting to modify the model), one or more outputs may be generated, possibly including a failure mode, effects and criticality analysis (FMECA), e.g. down to failure mode and with a 3 scale colour criticality indicator, a list of tasks, a probability of failure, cost data and a dashboard (such as a PowerBi dashboard).

The system may automatically determine the best strategy for operation, maintenance and end of life tasks for the asset, and such determination may be in accordance with one or more constraints imposed by the user such as technical or economical limitations. Similarly, the generation of outputs may be automated according to information such as labour, spares, resource and consequence costs, as well as other statistical probabilities of events.

As outlined above, the user 110 may interact with the system in any suitable manner to enter data and answer the questions associated with the governance framework.

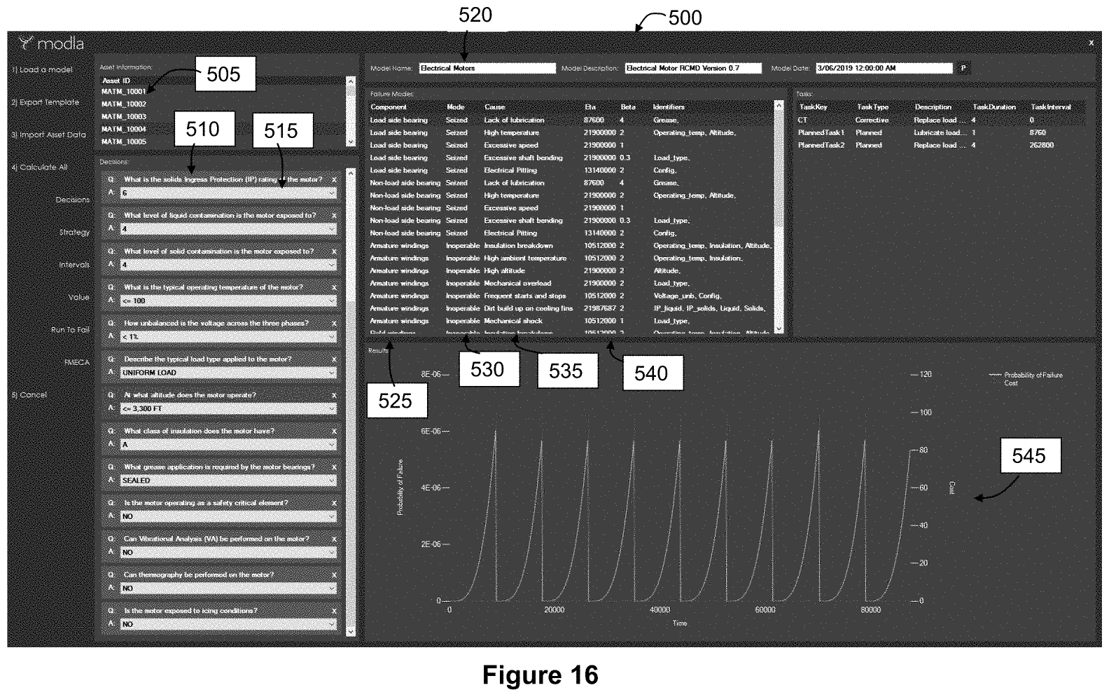

FIG. 16 illustrates a screenshot of a screen of a system according to a different embodiment compared to FIGS. 5-15. The screen enables users to interact with the system and respond to questions of the governance framework, as outlined below.

The screen includes a plurality of asset ID elements 505, which enables the user to add data relating to, and analyse a plurality of different assets. This is particularly useful in the case of a facility comprising many assets.

The screen further includes a plurality of questions 510, each associated with a drop down menu or data entry field 515 defining the acceptable answers to the question. Only permitting acceptable answers ensures consistency in the manner in which the results are input, which in turn alleviates the need to manually analyse the answers.

The questions 510 and drop down menu or data entry field 515 may be interactive. E.g. if a particular type of motor is selected in response to one question 510, this may trigger one or more related questions 510. Such configuration may avoid the situation where irrelevant questions are asked of users.

As each question is answered, an asset type model is dynamically updated to create a specific model. The asset type model is identified in a model name field 520, which enables the user to quickly see which asset type model has been used. In the case of FIG. 16, the asset type model is for electrical motors.

A failure modes region (shown in the screenshot in FIG. 16) is populated with a plurality of failure mode rows, each including a component element 525, defining a component of the specific model, a mode of failure element 530, defining a mode of failure associated with the component, a cause of failure element 535, defining a cause of failure associated with the failure mode, and probabilistic failure parameters 540, defining an Eta, Beta and Gamma as Weibull Parameters associated with the failure mode.

As the questions 510 are answered, the failure modes region is updated so that only relevant components and failure modes (etc) are shown.

Finally, the screen includes a plot 545 illustrating the probability of failure of the asset and cost over time. In this embodiment, as the questions 510 are answered, the plot 545 is updated so that it relates to the model as it is developed.

An asset type model may be tailored to a particular user or organisation and its environmental conditions by the governance framework. The framework may utilise user inputs to drive decisions to tailor the asset type model. A single decision has four core elements: 1) required information or question; 2) a range of acceptable answers for that information point or question; 3) an algorithm for processing the information given in the answers; and 4) a set of actions to be performed. These may be a culmination of expert opinion, data and information as well as standards and study results.

Equally, an asset type model and associated governance framework may be initially created for use across all users or organisations, and it may be updated over time, and thus constantly improve. In fact, the decisions themselves may be used to increase the quality of the model outputs over time. In particular, as the knowledge base grows, the decisions (and actions) may be modified to reflect new learnings. This means that new decisions can be added to a model, especially with the emergence of new technologies, and existing decisions updated.

A subject matter expert (SME) 145 may interact with the server 105 using a computing device 150 to input such further knowledge. This may be in response to an incident, to analysis, or for any reason, including periodically.

While only one subject matter expert 145 is illustrated, the skilled addressee will readily appreciate that many subject matter experts may provide data to the server 105. In such case, weighting may be used to increase reliability of a decision, as decisions with more experts and data backing them may be given more weight than those with few experts and data.

As an illustrative example, a subject matter expert may state that “Poor quality tires last half as long as the average tire”. A new decision may be created based thereon that asks for the quality of the tire and allows “Good”, “Average” and “Poor”. An action may then be created to reduce the life of the tires by 50% if “Poor” is selected.

As time goes on, new failure data is may be obtained (e.g. from 1000 samples) that shows that tire life is reduced by 40% for poor quality tires. This needs to be weighed off against the expert's opinion and combined using a weighted average.

The experts view may be given a weighting equivalent of 1000 samples, then the weighted average is now a 45% reduction ((1000×50+1000×40)/2000), and the action may be updated to now represent 2000 samples.

This can continue every time a new data set or opinion is introduced, and instead of using models built by just a single expert or organisation, large sets of data that can be utilised by all users of the system 100 are generated.

As a second illustrative example, a failure mode: “Steel corroded due to environment” is defined, together with possible Environment Corrosion Values being: “High”, “Medium” and “Low”.

In an initial sample of asset failures (1000 Samples), the relationship between the environment and failure rate may be determined through analysis (e.g. regression), and it may be seen that: 1) High Corrosion areas correspond to an average of 30% expected life reduction; 2) Medium Corrosion areas correspond to an average of 10% expected life reduction; and 3) Low Corrosion areas correspond to the expected life (Default Case Eta).

These are then configured in the decision such that selection of “High” results in an action of reducing the life of a steel component by 30% and Medium by 10%. No change is made to the life in Low Corrosion areas.

Another company which has similar assets may then perform a similar analysis (with 10000 samples) and find that: 1) High Corrosion areas correspond to an average of 20% expected life reduction; 2) Medium Corrosion areas correspond to an average of 7% expected life reduction; and 3) Low Corrosion areas correspond to a 2% reduction to the expected life (Default Case Eta).

This additional knowledge would result in the following changes to the model. In low corrosion areas the weighted average of samples may define a 1.81% ((10000×2%+1000×0%)/11000). Corresponding changes are made to medium and high corrosion areas.

Advantageously, the systems and methods described above provide a simple and efficient means to generate specific asset models, which may in turn be used to perform further asset analysis (where the further asset analysis is RCM, the system may be used to e.g. generate a maintenance plan, operational plan or intervention plan, etc, for the specific asset). In contrast to traditional RCM systems, the system alleviates the need for reliability centred maintenance experts and subject matter experts, and as such, may be used by non-expert or administrative staff associated with the asset.

Such configuration also simplifies the process of updating models over time, and the use of the governance framework enables knowledge to be captured across various organisations and industries.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A system for use in asset analysis including:
one or more asset type models, each asset type model relating to multiple individual assets having common characteristics and applications; and
a governance framework for each asset type model, the governance framework being configured or operable to convert the asset type model into a specific asset model corresponding to a specific asset, the specific asset having a condition and operating in an operational context and environment,
wherein
an asset type model is converted into a specific asset model for a specific asset based on a plurality of decisions defined by the governance framework for that asset type model,
the specific asset model is usable in an analysis associated with the specific asset, and
the decisions defined by the governance framework for an asset type model are made according to input and/or known data or information relating to, and any specific asset model created using that asset type model therefore contains information about, one or more of the following: the specific asset itself, the condition of the specific asset, the operational context in which the specific asset operates; and the environment in which the specific asset operates.

2. The system claimed in claim 1, wherein an asset type model is converted into a specific asset model for a specific asset at least in part by including, excluding/removing or otherwise modifying a part or item or attribute or feature included in the asset type model.

3. The system claimed in claim 1, wherein the governance framework for a given asset type model is operable to convert the asset type model into a specific asset model for a specific asset by one or more of: adding or removing a part or item of the asset type model; setting a failure characteristic of the specific asset; modifying a failure characteristic of the specific asset based on the condition of the specific asset; and setting a task associated with a component or the specific asset.

4. The system claimed in claim 1, wherein the governance framework associated with an asset type model comprises a plurality of questions and/or data inputs.

5. The system claimed in claim 4, wherein one or more actions are performed on the asset type model according to information provided in the answers to the questions and/or in the data inputs.

6. The system claimed in claim 4, wherein at least some of the questions in the governance framework associated with an asset type model each have a plurality of predefined answers, and there are one or more actions associated with different combinations of different predefined answers being provided to different questions.

7. The system claimed in claim 1, wherein an asset type model comprises a plurality of components, and a specific asset model created using the asset type model includes a subset of the plurality of components included in the asset type model.

8. The system claimed in claim 7, wherein each component is associated with one or more failure modes.

9. The system claimed in claim 4, wherein the system operates so that questions are provided to a user, and as the user responds to the questions, the asset type model is dynamically updated or modified so as to be converted into a specific asset model for the specific asset under consideration by the user once an answer has been provided to all questions.

10. The system claimed in claim 4, wherein answers to one or more questions, and/or data required to be entered in one or more data inputs, are imported or otherwise provided by another system and not manually input or provided by a (human) user.

11. The system claimed in claim 4, wherein answers to one or more questions, and/or data required to be entered in one or more data inputs, default to default answers/inputs in case the answer to a given question, and/or the input project to particular data input, is not known by a user or system providing the answers/inputs.

12. The system claimed in claim 1, wherein the system is also configured to analyse the specific asset model and to display results of the analysis.

13. The system claimed in claim 12, wherein the system is configured to perform reliability centred maintenance analysis (RCM) based on a specific asset model that has been created by the system.

14. The system claimed in claim 13, wherein the system is configured to analyze and display details of one or more of the following for the specific asset: a maintenance plan, an operational plan, an intervention plan, an inspection plan, risks, budgetary and resource information associated with any of these plans, expenditure over time, probability of failure over time, a list of failure modes, overlap min and max bounds for probability and cost.

15. The system claimed in claim 13, wherein the system is configured to generate one or more outputs based upon the analysis, the outputs including one or more of: a failure mode, effects and criticality analysis (FMECA); a list of tasks; a probability of failure; cost data; and a dashboard.

16. The system claimed in claim 13, wherein the system is configured to automatically determine a strategy for operation, maintenance and/or end of life tasks for the specific asset.

17. The system claimed in claim 1, wherein the system is configured to create specific asset models for, and optionally then perform asset analyses on, a plurality of specific assets.

18. The system claimed in claim 17, wherein the plurality of specific assets are bulk uploaded or loaded into the system in a file, or as a live or real-time feed from another system.

19. The system claimed in claim 1, wherein the system is configured to enable the governance framework and/or one or more of the asset type models to be updated.

20. A method for use in asset analysis, the method comprising:
providing one or more asset type models, each asset type model relating to multiple individual assets having common characteristics and applications;
providing a governance framework for each asset type model, the governance framework being configured or operable to convert the asset type model into a specific asset model corresponding to a specific asset, the specific asset having a condition and operating in an operational context and environment, and
enabling a user to convert an asset type model into a specific asset model for a specific asset based on a plurality of decisions defined by the governance framework for that asset type model,
wherein
the specific asset model is usable in a further analysis associated with the specific asset, and
the decisions defined by the governance framework for an asset type model are made according to data or information that is input by the user and/or known relating to, and any specific asset model created using that asset type model therefore contains information about, one or more of the following: the specific asset itself, the condition of the specific asset, the operational context in which the specific asset operates; and the environment in which the specific asset operates.
